(19) United States
(12) Patent Application Publication
(10) Pub. No.: US 2026/0214662 A1
(43) Pub. Date: Jul. 23, 2026

(54) WIRELESS COMMUNICATION METHOD REGARDING COMMUNICATION MODES, APPARATUS, AND COMPUTER-READABLE MEDIUM

(71) Applicant: ZTE Corporation, Shenzhen (CN)

(72) Inventors: Wei GOU, Shenzhen (CN); Xianghui HAN, Shenzhen (CN); Xingguang WEI, Shenzhen (CN); Shuaihua KOU, Shenzhen (CN)

(73) Assignee: ZTE Corporation, Shenzhen (CN)

(21) Appl. No.: 19/566,736

(22) Filed: Mar. 13, 2026

Related U.S. Application Data
(63) Continuation of application No. PCT/CN2023/121411, filed on Sep. 26, 2023.

(51) Int. Cl. H04W 72/11; H04W 72/23

(52) U.S. Cl. CPC H04W 72/11; H04W 72/23

(57) ABSTRACT

A wireless communication method includes configuring one or more modes for a transmission configuration based on a first parameter or a symbol type; performing a plurality of transmission occasions corresponding to the transmission configuration for uplink and/or downlink according to the one or more configured modes for the transmission configuration. Another wireless communication method includes determining one or more modes for a transmission configuration based on a first parameter or a symbol type; and performing a plurality of transmission occasions corresponding to the transmission configuration for uplink and/or downlink according to the one or more configured modes for the transmission configuration.

### TECHNICAL FIELD

This disclosure is generally related to wireless communication, and more particularly to recourse duplex wireless communication.

### BACKGROUND

Wireless communication technologies are pivotal components of the increasingly interconnecting global communication networks. Wireless communications rely on accurately allocated time and frequency resources for transmitting and receiving wireless signals. In order to improve the uplink (UL) coverage, UL latency, and UL capacity of TDD (time domain duplex) systems, Subband Full Duplex (SBFD) technology has been proposed.

### SUMMARY

This summary is a brief description of certain aspects of this disclosure. It is not intended to limit the scope of this disclosure.

According to some embodiments of this disclosure, a wireless communication method is disclosed. The method includes configuring one or more modes for a transmission configuration based on a first parameter or a symbol type; and performing a plurality of transmission occasions corresponding to the transmission configuration for uplink and/or downlink according to the one or more configured modes for the transmission configuration.

According to some embodiments of this disclosure, another wireless communication method is disclosed. The method includes determining one or more modes for a transmission configuration based on a first parameter or a symbol type; and performing a plurality of transmission occasions corresponding to the transmission configuration for uplink and/or downlink according to the one or more configured modes for the transmission configuration.

Still another embodiment of this disclosure provides a wireless communication apparatus, including one or more memory units storing one or more programs and one or more processors electrically coupled to the one or more memory units and configured to execute the one or more programs to perform any method or step or their combinations in this disclosure.

Still another embodiment of this disclosure provides non-transitory computer-readable storage medium, storing one or more programs, the one or more programs being configured to, when performed by at least one processor, cause to perform any method or step or their combinations in this disclosure.

According to some embodiments of this disclosure, one or more wireless communication methods are further disclosed, the methods include combinations of methods, aspects, elements, and steps (either in a generic view or specific view) disclosed in the various embodiments of this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows an exemplary Subband Full Duplex (SBFD) slot.

FIG. 2 shows an exemplary Co-Frequency Co-Time Full Duplex (CCFD).

FIG. 3 shows multiple exemplary slots configured with SPS PDSCHs corresponding to different configuration.

FIG. 4 shows multiple exemplary slots configured with SPS PDSCHs corresponding to different configuration.

FIG. 5 shows a wireless communication system structure.

### DETAILED DESCRIPTION

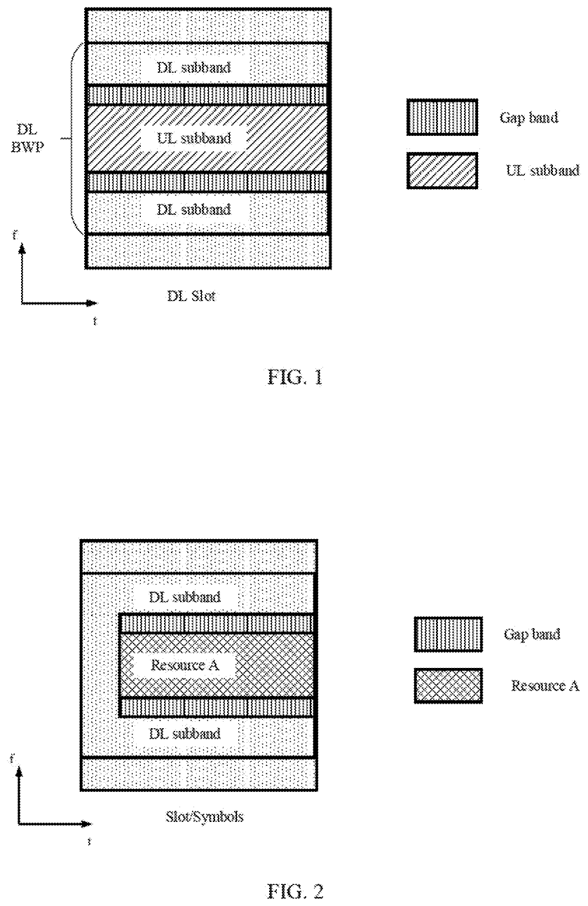

According to some examples of the Subband Full Duplex (SBFD) technologies, a uplink (UL) subband can be configured based on resource block (RB) sets. For example, in a TDD carrier of 100 MHz, 20 consecutive RBs are configured as a UL subband in the downlink (DL) symbols or slot. In this way as shown in FIG. 1, in the DL symbols or slot, the UL subband can be used for UL transmission, and the remaining frequency domain resources can be used for DL receptions as DL subbands.

UL subbands and DL subbands are also referred to as an SBFD subband. The OFDM symbol configured with an SBFD subbands is called an SBFD symbol. The slot including the SBFD symbol is called an SBFD slot. The OFDM symbol that is not configured with an SBFD subband is called a non-SBFD symbol (i.e. a regular symbol). A slot that is not configured with the SBFD symbol is called a non-SBFD slot (i.e. a regular slot).

The UL subband and DL subband hereinafter can also be referred to as an SBFD subband. The OFDM symbols configured with the SBFD subband can be called the SBFD symbols. The slot including the SBFD symbols can be called an SBFD slot. An OFDM symbol that is not configured with a SBFD subband can be called a non-SBFD symbol (or a regular symbol). A slot that is not configured with a SBFD symbol can be called a non-SBFD slot (or a regular slot).

In the related technology, due to the significant difference in the channel interference between transmissions or receptions in SBFD symbols/slots and transmissions or receptions in non-SBFD symbols/slots, the following agreement is reached for a channel or signal with repetitions or a channel or signal with periodicity.

For UL transmissions and DL receptions across SBFD symbols and non-SBFD
symbols in different slots (each transmission/reception within a slot has either all SBFD
or all non-SBFD symbols)

| | |
|---|---|
| - | Study the following options for SBFD-aware UEs: |
| | ∘ Option 1: The transmissions/receptions are restricted to SBFD |
| | symbols only or non-SBFD symbols only |
| | ∘ Option 2: The transmissions/receptions can be in SBFD |
| | symbols and non-SBFD symbols |
| - | UL transmissions and DL receptions across SBFD symbols and non-SBFD |
| | symbols include the following: |
| | ∘ PDSCH/PUSCH/PUCCH repetitions |
| | ∘ SPS PDSCH/CG PUSCH |
| | ∘ TBoMS |
| | ∘ Multi-PUSCH/PDSCH scheduled by a single DCI |
| | ∘ Periodic/semi-persistent SRS/CSI-RS/PUCCH |
| | ∘ PDCCH |

In this agreement, two transmission modes are proposed, namely option 1 and option 2. Furthermore, option 1 includes two transmission modes. For example, option 1-1 indicates the transmissions or receptions can only use SBFD symbols, and option 1-2 indicates transmissions or receptions can only use non-SBFD symbols.

Likewise, technologies of Co-Frequency Co-Time Full Duplex (CCFD) applications are promising to further improve system efficiency and spectral efficiency. Under its scenario, in a carrier, the base station (BS) can configure a series of time-frequency resources (denoted as Resource A) in some slots, as shown in FIG. 2. For the BS, Resource A can be used for CCFD applications. That is, the BS can send DL signals and receive UL signals in Resource A at the same time and at the same frequency.

In this application, the symbol/slot with Resource A configured is referred to as CCFD symbols/slots, while the symbols/slots without Resource A configured is referred to as non-CCFD symbols/slots (for example, regular symbols/slots).

Like the transmission modes of SBFD symbols/slots, due to the significant difference in the channel interference between transmissions or receptions in CCFD symbols/slots and transmissions or receptions in non-CCFD symbols/slots, two transmission modes are proposed for channels/signals with repetitions or periodicity, namely option 1A and option 2A. Furthermore, option 1A can include two transmission modes. For example, in option 1A-1, the transmissions/receptions are restricted to use CCFD symbols only. In option 1A-2, the transmissions/receptions are restricted to use non-CCFD symbols only. A proposal is presented below.

For UL transmissions or DL receptions across CCFD symbols and non-CCFD symbols
in different slots (each transmission/reception within a slot has either all CCFD or all
non-CCFD symbols)

| | |
|---|---|
| - | Study the following options for CCFD -aware UEs: |
| | ∘ Option 1A: The transmissions/receptions are restricted to |
| | CCFD symbols only or non-CCFD symbols only |
| | ∘ Option 2A: The transmissions/receptions can be in CCFD |
| | symbols and non-CCFD symbols |
| - | UL transmissions or DL receptions across CCFD symbols and non-CCFD |
| | symbols include the following: |
| | ∘ PDSCH/PUSCH/PUCCH repetitions |
| | ∘ SPS PDSCH/CG PUSCH |
| | ∘ TBoMS |
| | ∘ Multi-PUSCH/PDSCH scheduled by a single DCI |
| | ∘ Periodic/semi-persistent SRS/CSI-RS/PUCCH |
| | ∘ PDCCH |

In this disclosure, a semi-persistent scheduling PDSCH (SPS PDSCH) is used as an example to describe various channel/signal configuration methods and corresponding transmissions/receptions under SBFD applications or under CCFD applications. The methods and other aspects of this disclosure can be applied to other channels/signals, such as PDSCH/PUSCH/PUCCH repetitions, CG PUSCHs, TBoMS, Multi PUSCH/PDSCH scheduled by a single DCI, or periodic/semi persistent SRS/CSI-RS/PUCCH or PDCCH.

The following methods and other aspects of this disclosure are described as mainly focusing on transmissions/receptions based on SBFD applications as an example. But, the corresponding components in CCFD applications can replace the SBFD aspects in the disclosure below. SBFD symbols/slots can be replaced with CCFD symbols/slot, and non-SBFD symbols/slots be replaced with non-CCFD symbols/slots. Correspondingly, the transmission modes based on SBFD applications can also be replaced by the transmission modes based on CCFD applications. Option 1 can be replaced with option 1A, and option 2 can be replaced with option 2A. Option 1-1 can be replaced with option 1A-1, and option 1-2 can be replaced with option 1A-2.

### Transmission Modes

For UL transmissions or DL receptions with repetitions or periodicity across SBFD symbols and non-SBFD symbols in different slots (where each transmission/reception within a slot has either all SBFD symbols or all non-SBFD symbols), option 1 and option 2 are supported for SBFD-aware UE. For example, under option 1, the transmissions/receptions are restricted to either SBFD symbols only or non-SBFD symbols only among the repetitions or periodicity. For example, different repetitions cannot be in a SBFD symbols in one slot and in a non-SBFD symbols in another slot. Under option 2, the transmissions/receptions can be in SBFD symbols and non-SBFD symbols; that is, the restriction in option 1 does not exist under option 2.

Additionally or alternatively, option 1 can include two transmission modes, option 1-1 and option 1-2, for example. Under option 1-1, the transmissions/receptions are restricted to SBFD symbols only, in compliance with the restriction of option 1. Under option 1-2, the transmissions/receptions are restricted to non-SBFD symbols only, in compliance with the restriction of option 1.

The UL transmissions or DL receptions mentioned among this disclosure may include PDSCH or PUSCH or PUCCH repetitions, SPS PDSCHs, CG PUSCHs, TBoMS, Multi-PUSCH, Multi-PDSCH scheduled by a single DCI, or periodic or semi-persistent SRS/CSI-RS/PUCCHs/PDCCHs.

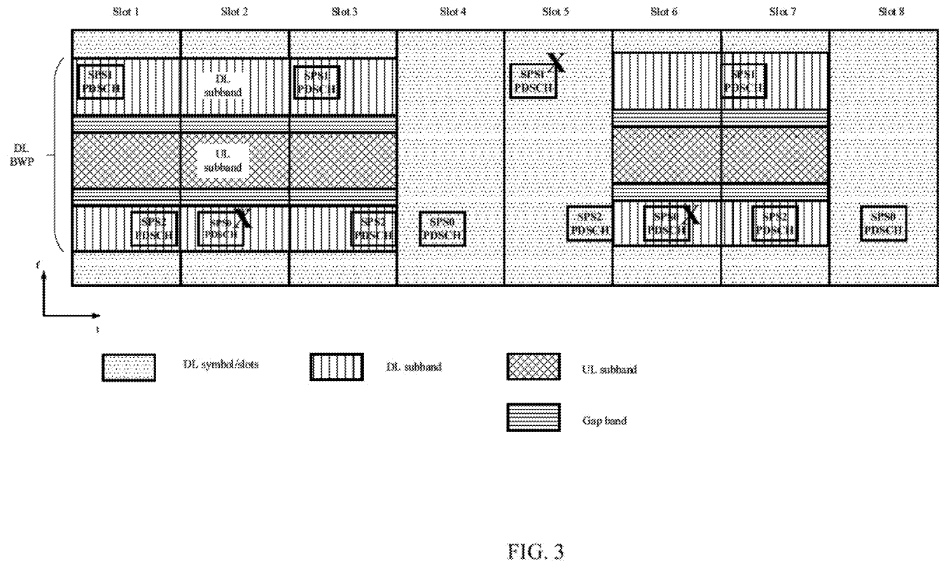

In FIG. 3, the DL receptions can be considered as multiple SPS PDSCHs corresponding to one SPS configuration, and the different transmission modes mentioned above are exemplified. Specifically, All SPS0 PDSCHs are consider under a same configuration. All SPS1 PDSCHs are consider under another configuration, and all SPS2 PDSCHs are consider under still another configuration.

In FIG. 3, the transmission occasions of the SPS configuration with index 1 are illustrated. If the corresponding configuration is configured with a transmission mode based on option 1-1, the transmission occasion in the fifth slot are prohibited (as indicated with the crossing-out) from transmitting SPS1 PDSCHs corresponding to the SPS configuration with index 1. In FIG. 3, the transmission occasions of the SPS configuration with index 0 are also illustrated. If the corresponding configuration is configured with a transmission mode based on option 1-2, the transmission occasions in the second and sixth slots (as indicated with the crossing-out) are prohibited from transmitting SPS0 PDSCHs corresponding to the SPS configuration with index 0. In FIG. 3, the transmission occasions of the SPS configuration with index 2 are illustrated. If it is configured with a transmission mode based on option 1-1, the transmission occasions in the 1st, 3rd, 5th, and 7th slots can be used to transmit SPS2 PDSCHs corresponding to the SPS configuration with index 2.

### UE (User Equipment) Capability Reporting

In real applications, the BS may need to know the capability of the user ends (like UE) to configure a proper transmission that is acceptable to the user ends. The BS and UE (such as SBFD-aware UE) may agree to introduce at least one of the following signalings in order to report the transmission mode(s) supported by the UE for UL transmissions or DL receptions across SBFD symbols and non-SBFD symbols in different slots. The signalings may include:

Signaling, which is used to report the transmission mode(s) supported by UE based on at least one of the above option 1 or option 2; Signaling, which is used to report the transmission mode(s) supported by UE based on at least one of the above option 1-1, option 1-2, or option 2; Signaling, which is used to report that UE can simultaneously support transmission modes based on the above option 1 and option 2; Signaling, which is used to report that UE can simultaneously support transmission modes based on the above option 1-1 and option 1-2; Signaling, which is used to report that UE can simultaneously support transmission modes based on the above option 1-1 and option 2; Signaling, which is used to report that UE can simultaneously support transmission modes based on the above option 1-2 and option 2; or Signaling, which is used to report that UE can simultaneously support transmission modes based on the above option 1-1, option 1-2, and option 2.

Additionally or alternatively, the BS and UE may further agree that, if the UE does not report (or the BS does not receive) the supported transmission mode(s) of it, the BS consider at least one functionality enumerated above to be reported by the signaling as default and the UE's functionality is as indicated by the default signaling. The default signaling can be predefined between the BS and UE. Additionally or alternatively, the UE and BS may consider at least one of the option 1, option 2, option 1-1, and option 1-2 as a default mode that is supported by UE. If the UE does not report (or the BS does not receive) the supported transmission mode(s) of it, BS considers UE supports the default mode(s) (or option(s)).

### Configuring and Transmission Mode(s) Determination

For UL transmissions or DL receptions with repetitions or periodicity across SBFD symbols and non-SBFD symbols in different slots (where each transmission/reception within a slot has either all SBFD or all non-SBFD symbols), based on option 1 (which may include option 1-1 and option 1-2) and option 2, exemplary methods for determining the transmission mode(s) of the UL transmissions or DL receptions are disclosed as follows. The different examples can be combined with each other, and the technical feature within different examples can be combined with each other.

### Example 1

The BS and UE may agree to introduce a parameter 1. This parameter 1 is used to configure the transmission mode based on option 1 or option 2 for UL transmissions or DL receptions across SBFD symbols and non-SBFD symbols in different slots (where each transmission/reception within a slot has either all SBFD or all non-SBFD symbols). This parameter 1 can be included in RRC signaling, so the parameter 1 can be transmitted from a BS to UE to configure the transmission mode; for example, it can be included in the configuration signaling of the UL transmissions or DL receptions.

For UL transmissions or DL receptions, the parameter 1 can be included in their respective configuration signaling. The transmission mode of UL transmissions or DL receptions is determined based on the value of the parameter 1. For example, if the DL receptions correspond to an SPS configuration, the parameter 1 can be included in the configuration signaling of the SPS configuration. For example, if the UL transmissions correspond to a CG PUSCH, the parameter 1 is included in the configuration signaling of the CG PUSCH.

Additionally or alternatively, a parameter 1 can also be associated with multiple UL transmissions or DL receptions simultaneously. In this case, the transmission modes of multiple UL transmissions or DL receptions are determined based on the same parameter 1. For example, two parameters 1 are included in the configuration signaling of the UL transmissions or DL receptions. The value of the first parameter 1 is “0”, and the transmission mode of one or more UL transmissions or DL receptions associated with the first parameter 1 is determined based on the value of the first parameter 1. The value of the second parameter 1 is “1”, and the transmission mode of one or more UL transmissions or DL receptions associated with the second parameter 1 is determined based on the value of the second parameter 1.

Additionally or alternatively, one parameter 1 can also be associated with multiple UL transmissions or DL receptions. The parameter 1 can be used to indicate whether the transmission mode of multiple UL transmissions or DL receptions is based on option 1 or option 2. For example, parameter 1 is a bitmap signaling. A number of the bits in this bitmap signaling is equal to the number of configured UL transmissions or DL receptions. The mapping relationship between the bitmap signaling and multiple configured UL transmissions or DL receptions is determined based on the index of the UL transmissions or DL receptions configuration. For example, the bits of the bitmap signaling correspond one-to-one from left to right with the ascending index order of the configurations of multiple UL transmissions or DL receptions.

Additionally or alternatively, the UL transmissions or DL receptions mentioned among this disclosure may include PDSCH or PUSCH or PUCCH repetitions, SPS PDSCHs, CG PUSCHs, TBoMS, Multi-PUSCHs, Multi-PDSCHs scheduled by a single DCI, or periodic or semi-persistent SRS/CSI-RS/PUCCHs/PDCCHs.

### Example 2

Additionally or alternatively, the BS and UE agree to introduce a parameter 2. This parameter 2 is used to configure the transmission mode based on option 1 for UL transmissions or DL receptions across SBFD symbols and non-SBFD symbols in different slots (where each transmission/reception within a slot has either all SBFD or all non-SBFD symbols). If parameter 2 is not provided, the BS and UE determine that a default transmission mode as option 2 to be applied.

Additionally or alternatively, the BS and UE agree to introduce a parameter 2. This parameter 2 is used to configure the transmission mode based on option 2 above for UL transmissions or DL receptions across SBFD symbols and non-SBFD symbols in different slots (where each transmission/reception within a slot has either all SBFD or all non-SBFD symbols). If parameter 2 is not provided, the BS and UE determine that a default transmission mode as option 1 to be applied.

Additionally or alternatively, this parameter 2 can be included in RRC signaling, so the parameter 2 can be transmitted from a BS to UE to configure the transmission mode; for example, it can be included in the configuration signaling of UL transmissions or DL receptions.

### Example 3

Additionally or alternatively, a BS and UE agree to introduce a parameter 3. This parameter 3 is used to configure the transmission mode based on option 1 (exemplarily including option 1-1 and/or option 1-2) or option 2 above for UL transmissions or DL receptions across SBFD symbols and non-SBFD symbols in different slots (where each transmission/reception within a slot has either all SBFD or all non-SBFD symbols).

Additionally or alternatively, this parameter 3 is included in an (activated) DCI corresponding to the UL transmissions or DL receptions. For example, for the UL transmissions/DL receptions corresponding to one or more SPS configurations, the PUCCH resource indicator (PRI) field and/or downlink assignment indicator (DAI) field in an activated DCI are used to indicate the transmission mode of the one or more SPS configurations (from the multiple options mentioned above). The activated DCI includes at least one of DCI format 1-0, DCI format 1-1, DCI format 1-2, DCI format 4-1, or DCI format 4-2. The activated DCI can be transmitted from a BS to UE to configure the transmission mode.

### Example 4

Additionally or alternatively, a BS and UE agree to introduce a parameter 4, and the parameter 4 can provide an indication from two candidate messages. The candidate messages includes at least one of: message 1, indicating transmission mode information (such as option 1 or option 2); or message 2, indicating that transmission mode is determined based on information in DCI.

That is, if message 1 is provided, by a BS to UE, from parameter 4, the transmission mode for the UL transmissions/DL receptions is based on message 1's information, which indicates transmission mode directly. Alternatively, if message 2 is provided, by a BS to UE, from parameter 4, the transmission mode corresponding to the UL transmissions/DL receptions is determined from a DCI corresponding to the UL transmissions/DL receptions. The DCI may indicate the transmission mode from the above options for the UL transmissions/DL receptions.

In the examples above, if option 1 is determined for the UL transmission/DL reception, the selection of option 1-1 or option 1-2 under option 1 can be determined for the UL transmission/DL reception based on at least one of Example 5 to Example 8 or their combination below.

### Example 5

Additionally or alternatively, a BS and UE agree to introduce a parameter 5. The parameter 5 is used to indicate the transmission mode for the UL transmissions/DL receptions from the 1-1 and option 1-2. The parameter 5 can be included in DCI or in RRC signaling between a BS and UE. Alternatively or additionally, the PRI and/or DAI in an (activated) DCI can be reinterpreted for indicating parameter 5.

Alternatively or additionally, the parameter 5 can provide an indication from two candidate messages. The candidate messages include message 1, which indicates a transmission mode based on the above option 1, and message 2, which indicates a transmission mode based on the above option 2. Additionally or alternatively, if message 1 is provided from the parameter 5, the transmission mode corresponding to the UL transmissions/DL receptions is determined from the a DCI corresponding to the UL transmissions/DL receptions. The DCI should indicate the transmission mode from the above option 1-1 and option 1-2 for the UL transmissions/DL receptions; for example, the PRI and/DAI in the (activated) DCI can be used to indicate option 1-1 or option 1-2.

### Example 6

Additionally or alternatively, the BS and UE agree to determine the transmission mode of the UL transmissions/DL receptions based on a symbol type of the symbol(s), in which the first transmission/reception occasion of the UL transmissions/DL receptions is located.

For example, if the first transmission/reception occasion of the UL transmissions/DL receptions is in a SBFD symbol, the transmission mode of the UL transmissions/DL receptions is determined, by UE and a BS, to be option 1-1. Alternatively, if the first transmission/reception occasion of the UL transmissions/DL receptions is in a non-SBFD symbol, the transmission mode of the UL transmissions/DL receptions is determined, by UE and a BS, to be option 1-2.

For example, if a first SPS PDSCH of an SPS configuration is received in the SBFD symbol, all SPS PDSCHs of the SPS configuration are determined, by the UE or BS, to be only received in the SBFD symbol (under option 1-1). If the first SPS PDSCH of an SPS configuration is received in a non-SBFD symbol, all SPS PDSCHs of the SPS configuration are determined, by the UE or BS, to be received only in the non-SBFD symbol (under option 1-2). The transmission mode of an SPS configuration is determined, by UE and a BS, based on the symbol type of the symbol, in which the first SPS PDSCH of the SPS configuration is located.

### Example 7

Additionally or alternatively, a BS and UE agree to determine the transmission mode of the UL transmissions/DL receptions based on a symbol type of the symbol(s) where a starting symbol of the first transmission/reception occasion of the UL transmissions/DL receptions is located.

For example, if the starting symbol of the first transmission/reception occasion of the UL transmissions/DL receptions is in a SBFD symbol, the transmission mode of the UL transmissions/DL receptions is determined, by the UE and BS, to be option 1-1. If the starting symbol of the first transmission/reception occasion of the UL transmissions/DL receptions is in a non-SBFD symbol, the transmission mode of the UL transmissions/DL receptions is determined, by the UE and BS, to be option 1-2.

For example, if the starting symbol of the first SPS PDSCH of an SPS configuration is in the SBFD symbol, all SPS PDSCHs of the SPS configuration are determined, by the UE and BS, to be only received in the SBFD symbol (under option 1-1). Alternatively, if the starting symbol of the first SPS PDSCH of an SPS configuration is in the non-SBFD symbol, all SPS PDSCHs of the SPS configuration are determined, by the UE and BS, to be received only in the non-SBFD symbol (under option 1-2). Accordingly, the transmission mode of an SPS configuration is determined based on the symbol type of the symbol(s) where the starting symbol of the first SPS PDSCH of the SPS configuration is located.

### Example 8

Additionally or alternatively, a BS and UE agree that the transmission mode of the UL transmissions/DL receptions is determined, by the BS and the UE, based on the resources of a PDCCH where the DCI corresponding to the UL transmissions/DL receptions is located.

For example, if the resources of the PDCCH, in which the DCI corresponding to the UL transmissions/DL receptions is received, are associated with SBFD symbol(s)/slot(s), the transmission mode of the UL transmissions/DL receptions is, determined by the BS and the UE, to be option 1-1. If the resources of the PDCCH, in which the DCI corresponding to the UL transmissions/DL receptions is received, are associated with the non-SBFD symbol/slot, the transmission mode of the UL transmissions/DL receptions is, determined by the BS and the UE, option 1-2.

For example, if an activated DCI corresponding to an SPS configuration is received in a PDCCH resource associated with SBFD symbol(s)/slot(s), all SPS PDSCHs of the SPS configuration are, determined by the BS and the UE, to be received only in the SBFD symbol (under option 1-1); if the activated DCI corresponding to an SPS configuration is received in a PDCCH resource associated with non-SBFD symbol(s)/slot(s), all SPS PDSCHs of the SPS configuration are, determined by the BS and the UE, to be only received in the non-SBFD symbol (under option 1-2). Accordingly, for an SPS configuration, based on the symbol type (SBFD symbol or non-SBFD symbol) of the symbols of the PDCCH resources, where the activated DCI corresponding to the SPS configuration is received, the BS and the UE can determine that all SPS PDSCHs in the SPS configuration are received only in the SBFD symbol or only in the non-SBFD symbol.

### Example 9

Additionally or alternatively, a BS and UE agree to introduce a parameter 9. The parameter 9 is used to indicate the transmission mode for the UL transmissions/DL receptions from the above option 1-1, option 1-2, and option 2. The parameter 9 can be included in DCI to be transmitted by a BS to UE, or parameter 9 is an RRC signaling to be transmitted by a BS to UE.

### Example 10

Additionally or alternatively, if the configuration information for UL transmissions/DL receptions is included in a message related to SBFD symbol/slot configuration, the transmission mode for the UL transmissions/DL receptions is, determined by the BS and the UE, to be option 1. Furthermore, based on one of the above examples, it is determined that the transmission mode for the UL transmissions/DL receptions is option 1-1 or option 1-2. Alternatively, if the configuration information for UL transmissions/DL receptions is included in a message related to SBFD symbol/slot configuration, the transmission mode for the UL transmissions/DL receptions is, determined by the BS and the UE, to be option 1-1.

Additionally or alternatively, if the configuration information for UL transmissions/DL receptions is included in a message related to non-SBFD symbol(s)/slot(s) (or a BWP) configuration, the transmission mode for the UL transmissions/DL receptions is, determined by the BS and the UE, to be option 1-2. Alternatively, if the configuration information for UL transmissions/DL receptions is included in a message related to non-SBFD symbol(s)/slot(s) (or a BWP) configuration, the transmission mode for the UL transmissions/DL receptions, determined by the BS and the UE, to be option 2.

### Example 11

Additionally or alternatively, a BS and UE agree that the transmission mode corresponding to UL transmissions/DL receptions is determined to be the same as the transmission mode reported by UE. Additionally or alternatively, the BS and UE agree that if a UE reports multiple transmission modes mentioned above, the latest or earliest reported transmission mode is supported for UL transmissions/DL receptions.

### Example 12

A BS and UE agree that the transmission mode of the UL transmissions/DL receptions is determined, by a BS and UE, based on a time domain resource allocated for the UL transmissions/DL receptions. For example, if the time domain resource allocated for UL transmissions/DL receptions is from a set of time domain resources associated with SBFD symbols/slots (or SBFD subbands, or DL subbands), the transmission mode for UL transmissions/DL receptions is, determined by the BS and the UE, to be option 1-1. For example, if a time domain resource allocated for UL transmissions/DL receptions is from the set of time domain resources associated with non-SBFD symbols/slots (or DL BWPs), the transmission mode for UL transmissions/DL receptions is, determined by the BS and the UE, to be on the above option 1-2.

### Receiving Rules for SPS PDSCH

For UL transmissions or DL receptions across SBFD symbols and non-SBFD symbols in different slots (where each transmission/reception within a slot has either all SBFD or all non-SBFD symbols), there are three applicable transmission modes, including: Option 1-1: the transmissions/receptions are restricted to SBFD symbols only. Option 1-2: The transmissions/receptions are restricted to non-SBFD symbols only. Option 2: The transmissions/receptions can be in SBFD symbols and non-SBFD symbols.

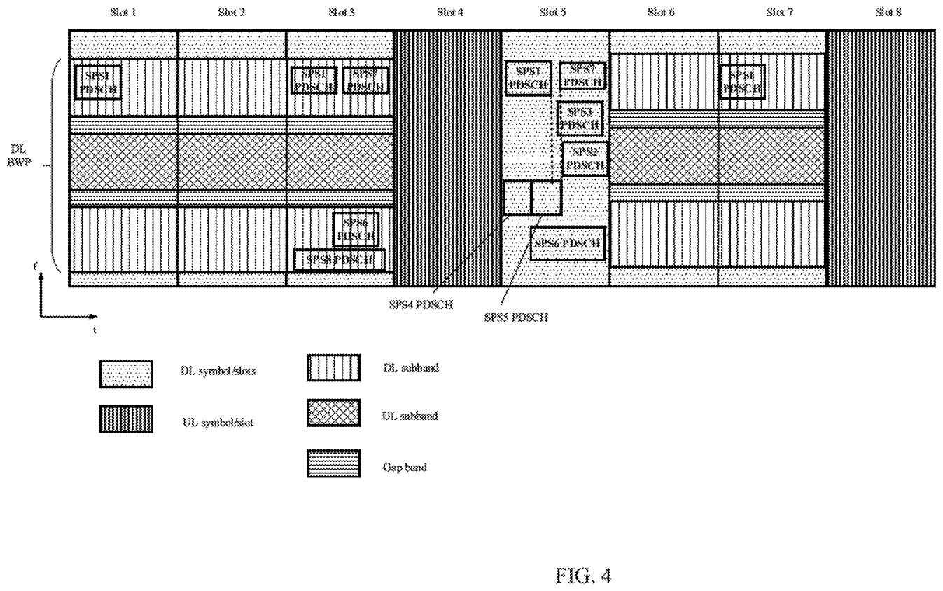

Assuming that the DL receptions are the SPS configuration, meaning that SPS PDSCH receptions follows one of the transmission modes mentioned above. In a slot, UE can receive one SPS PDSCH or multiple time-division SPS PDSCHs (as shown in FIG. 4) based on the UE's capability. Yet, if there are multiple SPS PDSCHs corresponding to multiple SPS configurations in a slot, including SPS PDSCHs based on the above transmission modes, an efficient approached need to be developed to select one or more proper SPS PDSCHs.

According to some embodiments of this disclosure, according to an agreement between a BS and UE, when there are multiples SPS PDSCHs corresponding to multiple SPS configurations in a slot, the received SPS PDSCHs can be determined based on the transmission mode(s) of the SPS configuration (including option 1-1, option 1-2, and option 2 mentioned above).

For examples, if multiple SPS PDSCHs corresponding to multiple SPS configurations are in a same slot, a BS and UE agree to determine which SPS PDSCHs need to be received (by the UE) or transmitted (by the BS) from these multiple SPS PDSCHs according to at least one of the following rules:

### Rule 1

If an SPS configuration from the multiple SPS configurations is configured with transmission mode(s) based on option 1-1 (only using SBFD symbols), and if all symbols of an SPS PDSCH corresponding to the SPS configuration overlap with a non-SBFD symbol in the time domain, or if at least one symbol of the SPS PDSCH overlaps with the non-SBFD symbol in the time domain, the SPS PDSCH is excluded from the multiple SPS PDSCHs in the slot. That is, the SPS PDSCH is not received.

Additionally or alternatively, if an SPS configuration from the multiple SPS configurations is configured with transmission mode(s) based on option 1-2 (only using non-SBFD symbols), and if all symbols of an SPS PDSCH corresponding to the SPS configuration overlap with a SBFD symbol in the time domain, or if at least one symbol of the SPS PDSCH overlaps with the SBFD symbol in the time domain, the SPS PDSCH is excluded from the multiple SPS PDSCHs in the slot. That is, the SPS PDSCH is not received.

### Rule 2

Additionally or alternatively, if an SPS configuration from the multiple SPS configurations is configured with transmission mode(s) based on option 1-1 (only using SBFD symbols), while N symbols of an SPS PDSCH overlap with non-SBFD symbols in the time domain, the SPS PDSCH is not excluded from the multiple SPS PDSCHs in the slot when N satisfies: L−N>2, where L is a number of symbols of the SPS PDSCH. The SPS PDSCH is still received. Otherwise (when L−N<2), the SPS PDSCH is excluded from the multiple SPS PDSCHs in the slot, meaning that the SPS PDSCH is not received. That is, if the SPS PDSCH includes at least 2 SBFD symbols (L−N>2), the SPS PDSCH is not excluded from the multiple SPS PDSCHs in the slot, so the SPS PDSCH will be transmitted by BS and received by the UE. 2 SBFD symbols is an example number, and which number can be adjusted according to different needs.

Additionally or alternatively, if an SPS configuration from the multiple SPS configurations is configured with transmission mode based on option 1-2 (only using non-SBFD symbols), while M symbols of the SPS PDSCH overlap with the SBFD symbol in the time domain and L−M>2, where L is the number of symbols of the SPS PDSCH, the SPS PDSCH is not excluded from the multiple SPS PDSCHs in the slot, meaning that the SPS PDSCH is received. Otherwise (if L−M<2), the SPS PDSCH is excluded from the multiple SPS PDSCHs in the slot, meaning that, the SPS PDSCH is not received. In this case, if the SPS PDSCH includes at least 2 non-SBFD symbols (L−M>2), the SPS PDSCH would not be excluded from the multiple SPS PDSCHs in the slot, meaning that the SPS PDSCH would be transmitted by the BS and received by the UE.

### Rule 3

Additionally or alternatively, if some or all of the resources (either time or frequency resources) of an SPS PDSCH in a slot overlap with resources of a UL subband, the SPS PDSCH is also excluded from the multiple SPS PDSCHs in the slot. That is, the SPS PDSCH would not be transmitted by the BS and received by the UE.

Additionally or alternatively, if all the resources (either time or frequency resources) of an SPS PDSCH in a slot are not in the resources of a DL subband, the SPS PDSCH is also excluded from the multiple SPS PDSCHs in the slot. That is, the SPS PDSCH would not be transmitted by the BS and received by the UE.

Based on executing at least one of Rules 1, 2, or 3 above, a set of candidate SPS PDSCH resources can be determined. According to some examples, UE and a BS can agree to use the following approaches to select the SPS PDSCH from the candidate set for transmission. For ease of description, the candidate SPS PDSCHs is referred to as set Q.
Step 1: From set Q, UE receives an SPS PDSCH corresponding to a SPS configuration with the smallest index. For ease of description, the received SPS PDSCH is referred to as selected SPS PDSCH.
Step 2: The selected SPS PDSCH and one or more SPS PDSCHs overlapping with the selected SPS PDSCH are excluded from set Q.
Step 1 and Step 2 are repeated until set Q is running out of candidate SPS PDSCHs or a number of the selected SPS PDSCHs equals G. G is equal to the number of PDSCHs in a slot supported by the UE based on a UE capability. The BS and UE agree that the selected SPS PDSCHs should be transmitted by the BS received by the UE.

FIG. 4 is used as an example to explain the operation of the above process. In FIG. 4 “SPS1 PDSCH” represents an SPS PDSCH, and the index of the SPS configuration corresponding to the SPS PDSCH is 1. “SPS2 PDSCH” represents an SPS PDSCH, and the index of the SPS configuration corresponding to the SPS PDSCH is 2. Likewise “SPSX PDSCH” represents an SPS PDSCH, and the index of the SPS configuration corresponding to the SPS PDSCH is X, X is an integer.

The period of the SPS configuration with SPS1 PDSCH is 2 slots as the two SPS1 PDSCHs are configured in slot 1 and slot 3. Here, this disclosure exemplarily assumes that the transmission mode configured for the SPS configurations with index 1 and index 6 is based on the above option 1-1. It is exemplarily assumed that the transmission mode configured for the SPS configuration with index 2, index 3, index 4, index 5 and index 8 is based on the above option 1-2. It is exemplarily assumed that the transmission mode configured for the SPS configuration with index 7 is based on the above option 2. It is also assumed that G, the number of PDSCHs in a slot supported by the UE based on UE capability, is 5.

The transmission occasions of SPS configurations with indexes 1 to 7 all appear in the fifth slot of FIG. 4. The transmission occasions of SPS configurations with index 1, index 6, index 7, and index 8 all appear in the third slot in FIG. 4. Furthermore, in FIG. 4, the SBFD subband is configured as shown in the figure. The first, second, third, sixth, and seventh slots are configured with the SBFD subbands (with both DL and UL subbands), which are the SBFD symbols/slots. The fifth slot is not configured with a SBFD subband (to include both DL and UL subbands), so the fifth slot is a non-SBFD symbol/slot. In the third slot of FIG. 4, it includes SPS1 PDSCH, SPS6 PDSCH, SPS7 PDSCH, and SPS8 PDSCH.

In the third slot, the transmission modes corresponding to SPS1 PDSCH and SPS6 PDSCH are based on option 1-1. The transmission mode corresponding to SPS8 PDSCH is based on option 1-2. The transmission mode corresponding to SPS7 PDSCH is based on option 2. The symbols in the third slot are all SBFD symbols. Due to the fact that SPS8 PDSCH is transmitted based on option 1-2, (using non-SBFD symbols/slots), but in the third slot, the symbols of SPS8 PDSCH overlap with SBFD symbols in the time domain, SPS8 PDSCH is excluded for the candidate list. SPS1 PDSCH, SPS6 PDSCH, and SPS7 PDSCH can be transmitted in SBFD symbols based on their corresponding transmission modes, so they are not excluded from the candidate list. Therefore, with respect to the third slot, set Q includes the remaining SPS1 PDSCH, SPS6 PDSCH, and SPS7 PDSCH.

Performing Step 1, UE should first receive (or the BS should first transmit) the SPS1 PDSCH because it has the smallest index from set S. SPS1 PDSCH is referred to as the selected SPS PDSCH.

Performing Step 2: SPS1 PDSCH and SPS6 PDSCH, which overlaps with SPS1 PDSCH are excluded from the candidate set Q.

Subsequently, Step 1 would be performed in view of the updated set Q. Here, only SPS7 PDSCH is remained in set Q. Step 1 and Step 2 are repeated alternately until the set Q has no remaining SPS PDSCH. In this way, the selected SPS PDSCH includes SPS1 PDSCH and SPS7 PDSCH, which means that the UE receives SPS1 PDSCH and SPS7 PDSCH in the third slot.

Turing to the fifth slot of FIG. 4, it includes SPS1 PDSCH, SPS2 PDSCH, SPS3 PDSCH, SPS4 PDSCH, SPS5 PDSCH, SPS6 PDSCH, and SPS7 PDSCH. It is assumed that the transmission modes corresponding to SPS1 PDSCH and SPS6 PDSCH are based on option 1-1 and that the transmission modes corresponding to SPS2 PDSCH, SPS3 PDSCH, SPS4 PDSCH, and SPS5 PDSCH are based on option 1-2. It is also assumed that the transmission mode corresponding to SPS7 PDSCH is based on option 2. The symbols in the fifth slot are all non-SBFD symbols, so due to the fact that SPS1 PDSCH and SPS6 PDSCH are transmitted based on option 1-1, i.e. using only SBFD symbols/slot, and in the fifth slot, the symbols of SPS1 PDSCH and SPS6 PDSCH overlap with non-SBFD symbols in the time domain, SPS1 PDSCH and SPS6 PDSCH are excluded. SPS2 PDSCH, SPS3 PDSCH, SPS4 PDSCH, SPS5 PDSCH, and SPS7 PDSCH can be transmitted by a BS in non-SBFD symbols based on their corresponding transmission modes, so they remain. For ease of description, set Q includes the remaining SPS2 PDSCH, SPS3 PDSCH, SPS4 PDSCH, SPS5 PDSCH, and SPS7 PDSCH.

Performing Step 1, UE would first receive the SPS2 PDSCH because it has the smallest index from set Q. SPS2 PDSCH is the referred to as the selected SPS PDSCH.

Performing Step 2, because SPS3 PDSCH and SPS7 PDSCH overlap with the selected SPS2 PDSCH in the time domain, SPS3 PDSCH and SPS7 PDSCH are excluded from set Q. The selected SPS2 PDSCH is also excluded from set Q.

Subsequently performing Step 1 based on the updated set Q with SPS2 PDSCH, SPS3 PDSCH, and SPS7 PDSCH excluded, the UE would receive SPS4 PDSCH with the smallest index from set Q.

Performing Step 2, the selected SPS4 PDSCH is excluded from set Q.

Subsequently performing Step 1, UE receives the SPS5 PDSCH with the smallest index from set Q. Subsequently, set Q is empty. UE stops selecting SPS PDSCH in the 5th slot. In this way, SPS2 PDSCH, SPS4 PDSCH, and SPS5 PDSCH are received in the fifth slot.

If assuming G=2, according to the above rules, in the fifth slot, when the number of selected SPS PDSCHs is equal to 2, the process of selecting SPS PDSCHs mentioned above is stopped. As a result, SPS2 PDSCH and SPS4 PDSCH are selected and received in the fifth slot, but not the third SPS5 PDSCH.

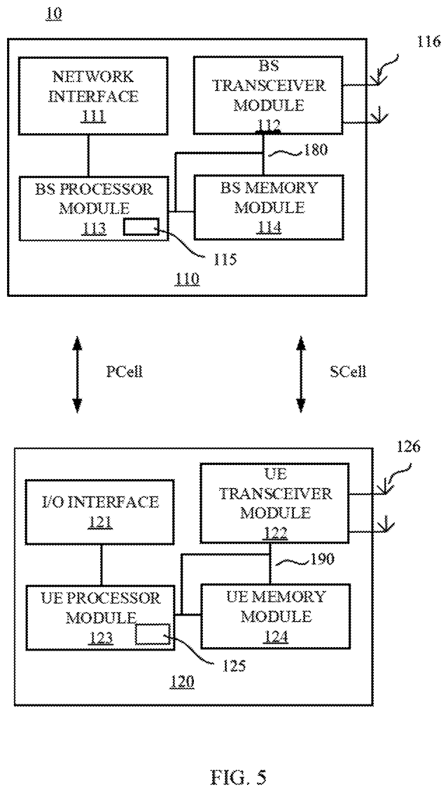

FIG. 5 illustrates a block diagram of an exemplary wireless communication system 10, in accordance with some embodiments of this disclosure. The system 10 may perform the methods/steps and their combination disclosed in this disclosure. The system 10 may include components and elements configured to support operating features that need not be described in detail herein.

The system 10 may include a base station (BS) 110 and user equipment (UE) 120. The BS 110 includes a BS transceiver or transceiver module 112, a BS antenna system 116, a BS memory or memory module 114, a BS processor or processor module 113, and a network interface 111. The components of BS 110 may be electrically coupled and in communication with one another as necessary via a data communication bus 180. Likewise, the UE 120 includes a UE transceiver or transceiver module 122, a UE antenna system 126, a UE memory or memory module 124, a UE processor or processor module 123, and an I/O interface 121. The components of the UE 120 may be electrically coupled and in communication with one another as necessary via a data communication bus 190. The BS 110 communicates with the UE 120 via communication channels therebetween, which can be any wireless channel or other medium known in the art suitable for transmission of data as described herein. The channels may include carriers of PCells and SCells.

The processor modules 113, 123 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 113, 123, respectively, or in any practical combination thereof. The memory modules 113, 123 may be realized as RAM memory, flash memory, EEPROM memory, registers, ROM memory, EPROM memory, a hard disk, a removable disk, a CD-ROM, or any other form of storage medium known in the art. In this regard, the memory modules 114, 124 may be coupled to the processor modules 113, 123 respectively, such that the processors modules 113, 123 can read information from, and write information to, memory modules 114, 124 respectively. The memory modules 114, 124 may also be integrated into their respective processor modules 113, 123. In some embodiments, the memory modules 114, 124 may each include a cache memory for storing temporary variables or other intermediate information during execution of instructions to be performed by processor modules 113, 123, respectively. The memory modules 114, 124 may also each include non-volatile memory for storing instructions to be performed by the processor modules 113, 123, respectively.

According to some embodiments, a wireless communication method is disclosed, which includes configuring one or more modes for a transmission configuration based on a first parameter or a symbol type; and performing a plurality of transmission occasions corresponding to the transmission configuration for uplink and/or downlink according to the one or more configured modes for the transmission configuration.

According to some examples, the first parameter is configured to show the mode of the transmission configuration can be either transmitted under a first mode or a second mode; and/or the first parameter is transmitted from RRC signaling; and/or the first parameter is used to indicate the mode of the one transmission configuration and the first parameter is included in the signaling used to configure the one transmission configuration; and/or the first parameter is used to indicate the mode of the multiple transmission configurations and the mode of the multiple transmission configurations is determined based on the same first parameter.

According to some examples, configuring one or more modes includes configuring the one or more modes for the transmission configuration base on whether the first parameter is present; and/or wherein if the first parameter is present, the transmission configuration is under a first mode, and alternatively if the first parameter is not present, the transmission configuration is under a second mode; if the first parameter is present, the transmission configuration is under a second mode, and alternatively if the first parameter is not present, the transmission configuration is under a first mode; and/or the first parameter is transmitted from RRC signaling; and/or the presence or absence of the first parameter indicates a mode of a specific transmission configuration; and/or the presence or absence of the first parameter indicates a mode of multiple transmission configurations; and/or the transmission configuration includes at least one SPS configuration.

According to some examples, the first parameter is configured to indicate the mode of the transmission configuration is a first mode, second mode, third mode, or fourth mode.

According to some examples, the method further includes transmitting the first parameter in one or more pieces of downlink control information (DCI), optionally the first parameter is indicated by a PRI field or a DAI field, and optionally format(s) of the one or more pieces of DCI include at least one of DCI format 1-0, DCI format 1-1, DCI format 1-2, DCI format 4-1, and DCI format 4-2.

According to some examples, the mode of the transmission configuration is indicated through the first parameter in RRC signaling; and/or the mode of the transmission configuration is indicated by combining a second parameter in RRC signaling with the first parameter in DCI, wherein the second parameter indicates the mode of the transmission configuration to be determined based on the first parameter in the DCI corresponding to the transmission configuration.

According to some examples, the first parameter is configured to indicate the transmission configuration is a third mode, or fourth mode.

According to some examples, the method further includes transmitting the first parameter in one or more pieces of downlink control information (DCI), optionally the first parameter is indicated by a PRI field or a DAI field; and/or the first parameter is configured to indicate the mode of the transmission configuration is a first mode in RRC signaling; and/or the mode of the transmission configuration is indicated to be a third mode or fourth mode in a DCI corresponding to the transmission configuration; and/or the first parameter is configured to indicate the mode of the transmission configuration is a second mode in RRC signaling and the second mode is used for the transmission configuration.

According to some examples, configuring one or more modes for a transmission configuration comprises configuring the mode of the transmission configuration based on a symbol type of symbols where the first occasion of the plurality of transmission occasions corresponding to the transmission configuration is located or based on a symbol type of a starting symbol of the first occasion.

According to some examples, the method further includes determining one or more SPS PDSCHs from multiple SPS PDSCHs as one or more candidate SPS PDSCHs in a slot by: if all symbols of an SPS PDSCH from the multiple SPS PDSCHs overlap with one or more second type symbols and the SPS configuration corresponding to the SPS PDSCH is configurated with a third mode, excluding the SPS PDSCH as a candidate SPS PDSCH; and/or if all symbols of an SPS PDSCH from the multiple SPS PDSCHs overlap with one or more first type symbols and the SPS configuration corresponding to the SPS PDSCH is configurated with a fourth mode, excluding the SPS PDSCH as a candidate SPS PDSCH; and/or if N symbols of an SPS PDSCH from the multiple SPS PDSCHs overlap with one or more second type symbols and the SPS configuration corresponding to the SPS PDSCH is configurated with a third mode, considering the SPS PDSCH as a candidate SPS PDSCH, where L−N>=C, L is a total number of the SPS PDSCH's symbols, C is an integer; and/or if N symbols of an SPS PDSCH from the multiple SPS PDSCHs overlap with one or more second type symbols and the SPS configuration corresponding to the SPS PDSCH is configurated with a third mode, excluding the SPS PDSCH as a candidate SPS PDSCH, where L−N<C, L is a total number of the SPS PDSCH's symbols, C is an integer; and/or if N symbols of an SPS PDSCH from the multiple SPS PDSCHs overlap with one or more first type symbols and the SPS configuration corresponding to the SPS PDSCH is configurated with a fourth mode, considering the SPS PDSCH as a candidate SPS PDSCH, where L−N>=C, L is a total number of the SPS PDSCH's symbols, C is an integer; and/or if N symbols of an SPS PDSCH from the multiple SPS PDSCHs overlap with one or more first type symbols and the SPS configuration corresponding to the SPS PDSCH is configurated with a fourth mode, excluding the SPS PDSCH as a candidate SPS PDSCH, where L−N<C, L is a total number of the SPS PDSCH's symbols, C is an integer; and/or if one or more resources of an SPS PDSCH from the multiple SPS PDSCHs overlap with a UL subband, excluding the SPS PDSCH as a candidate SPS PDSCH; and/or if all resources of an SPS PDSCH from the multiple SPS PDSCHs is out of DL subband resources, excluding the SPS PDSCH as a candidate SPS PDSCH; and/or determining one or more non-excluded SPS PDSCH as one or more candidate SPS PDSCHs.

According to some examples, the method further includes determining from the one or more candidate SPS PDSCHs as one or more selected SPS PDSCHs for reception by repeatedly perform steps of: determining an SPS PDSCH corresponding to the SPS configuration with a lowest index among the one or more candidate SPS PDSCHs as a selected SPS PDSCH; and disqualifying the selected SPS PDSCH and one or more candidate SPS PDSCHs having an overlap in time or frequency domain with the selected SPS PDSCH as candidate SPS PDSCHs to be selected.

According to some examples, the one or more occasions of uplink and/or downlink transmissions includes PDSCH/PUSCH/PUCCH repetitions, SPS PDSCHs/CG PUSCHs, TBoMS, Multi PUSCHs/PDSCHs scheduled by a single DCI, Periodic/semi persistent SRS/CSI-RS/PUCCHs or PDCCHs.

According to some examples under the first mode, a plurality of transmission occasions of one transmission configuration being all transmitted in either first type symbols or second type symbols; under the second mode, a plurality of transmission occasions of one transmission configuration being cable to be transmitted partially in first type symbols and partially in second type symbols; under the third mode, a plurality of transmission occasions of one transmission configuration being all transmitted in the first type symbols; and/or under the fourth mode, a plurality of transmission occasions of one transmission configuration being all transmitted in the second type symbols.

According to some examples, the first type symbols are SBFD symbols or Co-Frequency Co-Time Full Duplex (CCFD) symbols and the second type symbols are non-SBFD symbols or non-CCFD symbols.

According to some embodiments, another wireless communication method is disclosed, which includes determining one or more modes for a transmission configuration based on a first parameter or a symbol type; and performing a plurality of transmission occasions corresponding to the transmission configuration for uplink and/or downlink according to the one or more configured modes for the transmission configuration.

According to some examples, the first parameter is configured to show the mode of the transmission configuration can be either transmitted under a first mode or a second mode; and/or the first parameter is received from RRC signaling; and/or the first parameter is used to indicate the mode of the one transmission configuration and the first parameter is included in the signaling used to configure the one transmission configuration; and/or the first parameter is used to indicate the mode of the multiple transmission configurations and the mode of the multiple transmission configurations is determined based on the same first parameter.

According to some examples, determining one or more modes includes determining the one or more modes for the transmission configuration base on whether the first parameter is present; and/or if the first parameter is present, the transmission configuration is under a first mode, and alternatively if the first parameter is not present, the transmission configuration is under a second mode; if the first parameter is present, the transmission configuration is under a second mode, and alternatively if the first parameter is not present, the transmission configuration is under a first mode; and/or the first parameter is received from RRC signaling; and/or the presence or absence of the first parameter indicates a mode of a specific transmission configuration; and/or the presence or absence of the first parameter indicates a mode of multiple transmission configurations; and/or the transmission configuration includes at least one SPS configuration.

According to some examples, the first parameter is configured to indicate the mode of the transmission configuration is a first mode, second mode, third mode, or fourth mode.

According to some examples, the method further includes receiving the first parameter in one or more pieces of downlink control information (DCI), optionally the first parameter is indicated by a PRI field or a DAI field, and optionally format(s) of the one or more pieces of DCI include at least one of DCI format 1-0, DCI format 1-1, DCI format 1-2, DCI format 4-1, and DCI format 4-2.

According to some examples, the mode of the transmission configuration is indicated through the first parameter in RRC signaling; and/or the mode of the transmission configuration is indicated by combining a second parameter in RRC signaling with the first parameter in DCI, wherein the second parameter indicates the mode of the transmission configuration to be determined based on the first parameter in the DCI corresponding to the transmission configuration.

According to some examples, the first parameter is configured to indicate the transmission configuration is a third mode, or fourth mode.

According to some examples, the method further comprises receiving the first parameter in one or more pieces of downlink control information (DCI), optionally the first parameter is indicated by a PRI field or a DAI field; and/or the first parameter is configured to indicate the mode of the transmission configuration is a first mode in RRC signaling; and/or the mode of the transmission configuration is indicated to be a third mode or fourth mode in a DCI corresponding to the transmission configuration; and/or the first parameter is configured to indicate the mode of the transmission configuration is a second mode in RRC signaling, the second mode is used for the transmission configuration.

According to some examples, determining one or more modes for a transmission configuration comprises determining the mode of the transmission configuration based on a symbol type of symbols where the first occasion of the plurality of transmission occasions corresponding to the transmission configuration is located or based on a symbol type of a starting symbol of the first occasion.

According to some examples, one or more candidate SPS PDSCHs to be received in a slot are determined by: if all symbols of an SPS PDSCH from multiple SPS PDSCHs overlap with one or more second type symbols and the SPS configuration corresponding to the SPS PDSCH is configurated with a third mode, excluding the SPS PDSCH as a candidate SPS PDSCH; and/or if all symbols of an SPS PDSCH from the multiple SPS PDSCHs overlap with one or more first type symbols and the SPS configuration corresponding to the SPS PDSCH is configurated with a fourth mode, excluding the SPS PDSCH as a candidate SPS PDSCH; and/or if N symbols of an SPS PDSCH from the multiple SPS PDSCHs overlap with one or more second type symbols and the SPS configuration corresponding to the SPS PDSCH is configurated with a third mode, considering the SPS PDSCH as a candidate SPS PDSCH, where L−N>=C, L is a total number of the SPS PDSCH's symbols, C is an integer; and/or if N symbols of an SPS

PDSCH from the multiple SPS PDSCHs overlap with one or more second type symbols and the SPS configuration corresponding to the SPS PDSCH is configurated with a third mode, excluding the SPS PDSCH as a candidate SPS PDSCH, where L−N<C, L is a total number of the SPS PDSCH's symbols, C is an integer; and/or if N symbols of an SPS PDSCH from the multiple SPS PDSCHs overlap with one or more first type symbols and the SPS configuration corresponding to the SPS PDSCH is configurated with a fourth mode, considering the SPS PDSCH as a candidate SPS PDSCH, where L−N>=C, L is a total number of the SPS PDSCH's symbols, C is an integer; and/or if N symbols of an SPS PDSCH from the multiple SPS PDSCHs overlap with one or more first type symbols and the SPS configuration corresponding to the SPS PDSCH is configurated with a fourth mode, excluding the SPS PDSCH as a candidate SPS PDSCH, where L−N<C, L is a total number of the SPS PDSCH's symbols, C is an integer; and/or if one or more resources of an SPS PDSCH from the multiple SPS PDSCHs overlap with a UL subband, excluding the SPS PDSCH as a candidate SPS PDSCH; and/or if all resources of an SPS PDSCH from the multiple SPS PDSCHs is out of DL subband resources, excluding the SPS PDSCH as a candidate SPS PDSCH; and/or determining one or more non-excluded SPS PDSCH as one or more candidate SPS PDSCHs.

According to some examples, the method further includes receiving one or more selected SPS PDSCHs determined from the one or more candidate SPS PDSCHs by repeatedly-performed steps of: determining an SPS PDSCH corresponding to the SPS configuration with a lowest index among the one or more candidate SPS PDSCHs as a selected SPS PDSCH; and disqualifying the selected SPS PDSCH and one or more candidate SPS PDSCHs having an overlap in time or frequency domain with the selected SPS PDSCH as candidate SPS PDSCHs to be selected.

According to some examples, the one or more occasions of uplink and/or downlink transmissions includes PDSCH/PUSCH/PUCCH repetitions, SPS PDSCHs/CG PUSCHs, TBoMS, Multi PUSCHs/PDSCHs scheduled by a single DCI, Periodic/semi persistent SRS/CSI-RS/PUCCHs or PDCCHs.

According to some examples under the first mode, a plurality of transmission occasions of one transmission configuration being all transmitted in either first type symbols or second type symbols; under the second mode, a plurality of transmission occasions of one transmission configuration being cable to be transmitted partially in first type symbols and partially in second type symbols; under the third mode, a plurality of transmission occasions of one transmission configuration being all transmitted in the first type symbols; and/or under the fourth mode, a plurality of transmission occasions of one transmission configuration being all transmitted in the second type symbols.

According to some examples, the first type symbols are SBFD symbols or Co-Frequency Co-Time Full Duplex (CCFD) symbols and the second type symbols are non-SBFD symbols or non-CCFD symbols.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For occasion, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1-30. (canceled)

31. A wireless communication method, comprising:
configuring, by a base station, a mode for a communication based on whether or not a Radio Resource Control (RRC) parameter is provided to a user equipment (UE), wherein the mode comprises a first mode in which a plurality of uplink transmissions or a plurality of downlink receptions corresponding to the communication are restricted to subband full duplex (SBFD) symbols only or non-SBFD symbols only, or a second mode in which the plurality of uplink transmissions or downlink receptions corresponding to the communication are allowed to be in SBFD symbols and non-SBFD symbols in different slots; and
receiving the plurality of uplink transmissions or performing the plurality of downlink receptions according to the mode configured for the communication, wherein, if the RRC parameter is not provided to the UE, the first mode is configured, and if the RRC parameter is provided to the UE, the second mode is configured.

32. The method of claim 31, wherein:
the RRC parameter is transmitted via RRC signaling; and/or
the RRC parameter is defined as a reception or transmission configuration in SBFD; and/or
in the first mode, PDSCH receptions corresponding to the plurality of downlink receptions are restricted to SBFD symbols only or non-SBFD symbols only in a DL BWP; and/or
in the second mode, PDSCH receptions corresponding to the plurality of downlink receptions are allowed to be in SBFD symbols or non-SBFD symbols in different slots in a DL BWP; and/or
the RRC parameter is included in RRC signaling within a bandwidth part dedicated information element.

33. The method of claim 31, wherein:
when the UE is provided with the RRC parameter, the UE can receive a first PDSCH reception or a first repetition of a PDSCH in non-SBFD symbols and receive a second PDSCH or a second reception of the PDSCH in SBFD symbols; and/or
when the UE is provided with the RRC parameter, the UE can transmit a first uplink transmission or a first repetition of a uplink transmission in non-SBFD symbols and transmit a second uplink transmission or a second repetition of the uplink transmission in SBFD symbols; and/or
when the RRC parameter is not provided to the UE, a valid symbol type for the plurality of uplink transmissions or downlink receptions corresponding to the communication is determined based on a symbol type corresponding to a first uplink transmission occasion or first downlink reception occasion corresponding to the plurality of uplink transmissions or downlink receptions corresponding to the communication;
and/or when the RRC parameter is not provided to the UE, a valid symbol type for the communication is indicated by a symbol type parameter included in configuration signaling for the communication, wherein the symbol type parameter indicates that the valid symbol type for the communication is SBFD symbol or non-SBFD symbol; and/or
when the RRC parameter is not provided to the UE, the UE only performs the plurality of uplink transmissions or downlink receptions corresponding to the communication in a valid symbol type; and/or
the RRC parameter is transmitted via RRC signaling; and/or
a presence or absence of the RRC parameter indicates a mode of a specific communication; and/or
a presence or absence of the RRC parameter indicates a mode of multiple communications,
wherein the communication includes at least one of: a PDSCH, a PDSCH reception with repetitions, an SPS PDSCH reception, a PUSCH communication with repetitions, a configured grant PUSCH, a TBoMS, a multi-PUSCH or multi-PDSCH scheduled by a single DCI, or a periodic or semi-persistent SRS/CSI-RS/PUCCH or PDCCH, and
wherein the UE does not expect that first uplink transmission occasion or first downlink reception occasion corresponding to the plurality of uplink transmissions or downlink receptions corresponding to the communication is mapped to both SBFD symbols and non-SBFD symbols.

34. The method of claim 31, further comprising:
determining whether to transmit the RRC parameter in Radio Resource Control (RRC) signaling to the UE, wherein the RRC parameter is not provided to the UE when the first mode is configured, and wherein the RRC parameter is provided to the UE when the second mode is configured, and wherein the communication includes at least one of: a PDSCH, a PDSCH reception with repetitions, an SPS PDSCH reception, a PUSCH communication with repetitions, a configured grant PUSCH, a TBoMS, a multi-PUSCH or multi-PDSCH scheduled by a single DCI, or a periodic or semi-persistent SRS/CSI-RS/PUCCH or PDCCH; or
transmitting the RRC parameter in one or more pieces of downlink control information (DCI), wherein the RRC parameter is optionally indicated by a PUCCH resource indicator (PRI) field or a downlink assignment indicator (DAI) field, and wherein the one or more pieces of DCI include at least one of DCI format 1-0, DCI format 1-1, DCI format 1-2, DCI format 4-1, and DCI format 4-2.

35. The method of claim 31, wherein:
the first mode is indicated based on not providing the RRC parameter to the UE; and/or
the second mode of communication is indicated based on providing the RRC parameter to the UE; and/or
the mode of the communication is indicated by combining a second RRC parameter in RRC signaling with a first parameter in DCI, wherein the second RRC parameter indicates the mode of the communication to be determined based on the RRC parameter in the DCI corresponding to the communication; and/or
a valid symbol type for the communication is indicated by a symbol type parameter included in configuration signaling for the communication, wherein the symbol type parameter indicates whether the valid symbol type for the communication is SBFD or non-SBFD; and/or
the RRC parameter comprises a first candidate message and a second candidate message, wherein the first candidate message indicates the mode of the communication as the first mode or the second mode, and wherein the second candidate message indicates that the mode of the communication is to be determined based on information in DCI corresponding to the communication.

36. The method of claim 31, further comprising: when the RRC parameter is not provided to the UE, determining a valid symbol type of the communication based on a symbol type of a symbol in which a first transmission occasion of a plurality of transmission occasions corresponding to the communication is located, or based on a symbol type of a starting symbol of the first transmission occasion, wherein:
if the first transmission occasion is located in an SBFD symbol, the valid symbol type for the communication is SBFD,
if the first transmission occasion is located in a non-SBFD symbol, the valid symbol type for the communication is non-SBFD, and
the UE does not expect that the first transmission occasion corresponding to the communication is mapped to both SBFD symbols and non-SBFD symbols.

37. The method of claim 31, further comprising determining one or more SPS PDSCHs to be received in a slot from a plurality of SPS PDSCH by:
if an SPS PDSCH contains both SBFD symbols and non-SBFD symbols within the slot, the SPS PDSCH is deleted or excluded; and/or
if a symbol type of a symbol contained in an SPS PDSCH is not its corresponding valid symbol type, the SPS PDSCH is deleted or excluded; and/or
if all symbols of an SPS PDSCH in an SPS configuration are non-SBFD symbols, then the SPS PDSCH is deleted or excluded; and/or
if all symbols of an SPS PDSCH of the SPS configuration are SBFD symbols, then the SPS PDSCH is deleted or excluded; and/or
if N symbols of an SPS PDSCH overlap with non-SBFD symbols and a valid symbol type for the SPS configuration is SBFD symbols, the SPS PDSCH is a candidate SPS PDSCH where L−N>C, L is a total number of symbols of the SPS PDSCH, and C is an integer, and the SPS PDSCH is excluded where L−N<C; and/or
if N symbols of an SPS PDSCH overlap with SBFD symbols and a valid symbol type for the SPS configuration is non-SBFD symbols, the SPS PDSCH is a candidate SPS PDSCH occasion where L−N>C, L is a total number of symbols of the SPS PDSCH, and C is an integer, and the SPS PDSCH is excluded where L−N<C; and/or
if N symbols of an SPS PDSCH overlap with non-SBFD symbols and the SPS configuration only uses SBFD symbols, the SPS PDSCH is NOT excluded when L−N>2, but is excluded when L−N<2; and/or
excluding an SPS PDSCH that is mapped to both SBFD symbols and non-SBFD symbols within the slot; and/or
excluding an SPS PDSCH wherein all symbols of the SPS PDSCH are of a symbol type that is not a valid symbol type corresponding to its SPS configuration; and/or
excluding the SPS PDSCH if all symbols of the SPS PDSCH are non-SBFD symbols, and if a valid symbol type for the SPS configuration is non-SBFD symbols, excluding the SPS PDSCH if all symbols of the SPS PDSCH are SBFD symbols and if the valid symbol type for the SPS configuration is non-SBFD symbols, excluding the SPS PDSCH if all symbols of the SPS PDSCH are SBFD symbols; and/or
if all symbols of an SPS PDSCH from multiple SPS PDSCHs overlap with one or more second type symbols and the SPS configuration corresponding to the SPS PDSCH is configured with a third mode, excluding the SPS PDSCH as a candidate SPS PDSCH; and/or
if all symbols of an SPS PDSCH from the multiple SPS PDSCHs overlap with one or more first type symbols and the SPS configuration corresponding to the SPS PDSCH is configured with a fourth mode, excluding the SPS PDSCH as a candidate SPS PDSCH occasion; and/or
if N symbols of an SPS PDSCH from the multiple SPS PDSCHs overlap with one or more second type symbols and the SPS configuration corresponding to the SPS PDSCH is configured with a third mode, considering the SPS PDSCH as a candidate SPS PDSCH, where L−N>=C, L is a total number of the SPS PDSCH's symbols, C is an integer; and/or
if N symbols of an SPS PDSCH from the multiple SPS PDSCHs overlap with one or more second type symbols and the SPS configuration corresponding to the SPS PDSCH is configured with a third mode, excluding the SPS PDSCH as a candidate SPS PDSCH, where L−N<C, L is a total number of the SPS PDSCH's symbols, C is an integer; and/or
if N symbols of an SPS PDSCH from the multiple SPS PDSCHs overlap with one or more first type symbols and the SPS configuration corresponding to the SPS PDSCH is configured with a fourth mode, considering the SPS PDSCH as a candidate SPS PDSCH, where L−N>=C, L is a total number of the SPS PDSCH's symbols, C is an integer; and/or
if N symbols of an SPS PDSCH from the multiple SPS PDSCHs overlap with one or more first type symbols and the SPS configuration corresponding to the SPS PDSCH is configured with a fourth mode, excluding the SPS PDSCH as a candidate SPS PDSCH, where L−N<C, L is a total number of the SPS PDSCH's symbols, C is an integer; and/or
excluding an SPS PDSCH if one or more resources of the SPS PDSCH overlap with resources of a UL subband; and/or
excluding an SPS PDSCH if all resources of the SPS PDSCH are outside the resources of a DL subband, or if the SPS PDSCH is out of the DL subband; and/or
determining one or more non-excluded SPS PDSCHs as one or more candidate SPS PDSCH.

38. The method of claim 31, further comprising receiving or transmitting one or more candidate SPS PDSCHs determined from one or more candidate SPS PDSCHs by performing steps of:
setting j=0 and designating Q as a set of candidate SPS PDSCH within a slot;
receiving a SPS PDSCH corresponding to an SPS configuration with the lowest configured sps-ConfigIndex within Q, setting j−j+1, and designating the received SPS PDSCH as a survivor SPS PDSCH;
excluding from Q the survivor SPS PDSCH and any other SPS PDSCH occasions overlapping with the survivor SPS PDSCH; and
repeating the receiving and excluding steps until Q is empty or j is equal to the number of PDSCHs in a slot supported by the UE.

39. The method of claim 31, wherein a plurality of transmission occasions of uplink and/or downlink transmissions include at least one of: PDSCH/PUSCH/PUCCH repetitions, SPS PDSCHs/CG PUSCHs, TBoMS, multi PUSCHs/PDSCHs scheduled by a single DCI, periodic/semi persistent SRS/CSI-RS/PUCCHs, or PDCCHs.

40. A wireless communication method, comprising:
determining, by a user equipment (UE), a mode for a communication based on whether or not a Radio Resource Control (RRC) parameter is provided to the UE, wherein the mode comprises a first mode in which a plurality of uplink transmissions or a plurality of downlink receptions corresponding to the communication are restricted to subband full duplex (SBFD) symbols only or non-SBFD symbols only, or a second mode in which the plurality of uplink transmissions or downlink receptions corresponding to the communication are allowed to be in SBFD symbols and non-SBFD symbols in different slots; and
performing a plurality of uplink transmission or downlink reception corresponding to the communication according to the mode for the communication, wherein, if the RRC parameter is not provided to the UE, the first mode is configured, and if the RRC parameter is provided to the UE, the second mode is configured.

41. The method of claim 40, wherein:
the RRC parameter is received via RRC signaling; and/or
the RRC parameter is defined as reception or transmission configuration in SBFD; and/or
in the first mode, PDSCH receptions corresponding to the plurality of downlink receptions are restricted to SBFD symbols only or non-SBFD symbols only in a DL BWP; and/or
in the second mode, PDSCH receptions corresponding to the plurality of downlink receptions are allowed to be in SBFD symbols or non-SBFD symbols in different slots in a DL BWP; and/or
the RRC parameter is included in the RRC signaling within a bandwidth part dedicated information element.

42. The method of claim 40, wherein:
when the UE is provided with RRC parameter, the UE can receive a first PDSCH reception or a first PDSCH repetition of a PDSCH in non-SBFD symbols and receive a second PDSCH reception or a second PDSCH repetition of the PDSCH in SBFD symbols within a downlink BWP; and/or;
when the UE is provided with the RRC parameter, the UE can transmit a first uplink transmission or a first repetition of a uplink transmission in non-SBFD symbols and transmit a second uplink transmission or a second repetition of the uplink transmission in SBFD symbols; and/or
when the RRC parameter is not provided to the UE, a valid symbol type for the plurality of uplink transmissions or downlink receptions corresponding to the communication is determined based on a symbol type corresponding to a first uplink transmission occasion or first downlink reception occasion corresponding to the plurality of uplink transmissions or downlink receptions corresponding to the communication; and/or
when the RRC parameter is not provided to the UE, a valid symbol type for the communication is indicated by a symbol type parameter included in configuration signaling for the communication, wherein the symbol type parameter indicates that the valid symbol type for the communication is SBFD symbol or non-SBFD symbol; and/or
when the RRC parameter is not provided to the UE, the UE only performs the plurality of uplink transmissions or downlink receptions corresponding to the communication in a valid symbol type; and/or
the RRC parameter is received via RRC signaling; and/or
a presence or absence of the RRC parameter indicates a mode of a specific communication configuration; and/or
a presence or absence of the RRC parameter indicates a mode of multiple communication configurations, wherein the communication includes at least one of: a PDSCH, a PDSCH reception with repetitions, an SPS PDSCH reception, a PUSCH communication with repetitions, a configured grant PUSCH, a TBoMS, a multi-PUSCH or multi-PDSCH scheduled by a single DCI, or a periodic or semi-persistent SRS/CSI-RS/PUCCH or PDCCH, and wherein the UE does not expect that first uplink transmission occasion or first downlink reception occasion corresponding to the plurality of uplink transmissions or downlink receptions corresponding to the communication is mapped to both SBFD symbols and non-SBFD symbols.

43. The method of claim 40, further comprising:
determining whether to transmit the RRC parameter in Radio Resource Control (RRC) signaling to the UE, wherein the RRC parameter is not provided to the UE when the first mode is configured, and wherein the RRC parameter is provided to the UE when the second mode is configured, and wherein the communication includes at least one of: a PDSCH reception with repetitions, an SPS PDSCH reception, a PUSCH communication with repetitions, a configured grant PUSCH, a TBoMS, a multi-PUSCH or multi-PDSCH scheduled by a single DCI, or a periodic or semi-persistent SRS/CSI-RS/PUCCH or PDCCH; or
receiving the RRC parameter in one or more pieces of downlink control information (DCI), wherein the RRC parameter is optionally indicated by a PRI field or a DAI field, and wherein the one or more pieces of DCI include at least one of DCI format 1-0, DCI format 1-1, DCI format 1-2, DCI format 4-1, and DCI format 4-.

44. The method of claim 40, wherein:
the first mode of the communication is indicated based on not receiving the RRC parameter by the UE; and/or
the second mode of communication is indicated based on receiving the RRC parameter by the UE; and/or
the mode of the communication is indicated by combining a second RRC parameter in RRC signaling with a first parameter in DCI, wherein the second RRC parameter indicates the mode of the communication to be determined based on the RRC parameter in the DCI corresponding to the communication; and/or
in response to the first mode being provided, a valid symbol type for the communication is indicated by a symbol type parameter included in configuration signaling for the communication, wherein the symbol type parameter indicates whether the valid symbol type for the communication is SBFD or non-SBFD; and/or
the RRC parameter comprises a first candidate message and a second candidate message, wherein the first candidate message directly indicates the mode of the communication as the first mode or the second mode, and wherein the second candidate message indicates that the mode of the communication is to be determined based on information in DCI corresponding to the communication.

45. The method of claim 40, wherein, when the RRC parameter is not provided to the UE, the method further comprises determining a valid symbol type of the communication based on a symbol type of a symbol in which a first transmission occasion of a plurality of transmission occasions corresponding to the communication is located or based on a symbol type of a starting symbol of the first transmission occasion, wherein
if the first transmission occasion is located in an SBFD symbol, the valid symbol type for the communication is SBFD, and
if the first transmission occasion is located in a non-SBFD symbol, the valid symbol type for the communication is non-SBFD, wherein the UE does not expect that the first transmission occasion corresponding to the communication is mapped to both SBFD symbols and non-SBFD symbols.

46. The method of claim 40, wherein one or more candidate SPS PDSCHs to be received in a slot from a plurality of SPS PDSCHs are determined by:
if an SPS PDSCH contains both SBFD symbols and non-SBFD symbols within the slot, the SPS PDSCH is deleted or excluded; and/or
if a symbol type of a symbol contained in an SPS PDSCH is not its corresponding valid symbol type, the SPS PDSCH is deleted or excluded; and/or
if all symbols of an SPS PDSCH in an SPS configuration are non-SBFD symbols, then the SPS PDSCH is deleted or excluded; and/or
if all symbols of an SPS PDSCH of the SPS configuration are SBFD symbols, then the SPS PDSCH is deleted or excluded; and/or
if N symbols of an SPS PDSCH overlap with non-SBFD symbols and the valid symbol type for the SPS configuration is SBFD symbols, the SPS PDSCH is a candidate SPS PDSCH where L−N>C, L is a total number of symbols of the SPS PDSCH, and C is an integer, and the SPS PDSCH is excluded where L−N<C; and/or
if N symbols of an SPS PDSCH overlap with SBFD symbols and the valid symbol type for the SPS configuration is non-SBFD symbols, the SPS PDSCH is a candidate SPS PDSCH where L−N>C, L is a total number of symbols of the SPS PDSCH, and C is an integer, and the SPS PDSCH is excluded where L−N<C; and/or
if N symbols of an SPS PDSCH overlap with non-SBFD symbols and the SPS configuration only uses SBFD symbols, the SPS PDSCH is NOT excluded when L−N>2, but is excluded when L−N<2; and/or
excluding an SPS PDSCH that is mapped to both SBFD symbols and non-SBFD symbols within the slot; and/or
excluding an SPS PDSCH wherein all symbols of the SPS PDSCH are of a symbol type that is not a valid symbol type corresponding to its SPS configuration, wherein if a valid symbol type for the SPS configuration is SBFD symbols, excluding the SPS PDSCH if all symbols of the SPS PDSCH are non-SBFD symbols, and if the valid symbol type for the SPS configuration is non-SBFD symbols, excluding the SPS PDSCH if all symbols of the SPS PDSCH are SBFD symbols; and/or
if all symbols of an SPS PDSCH from multiple SPS PDSCHs overlap with one or more second type symbols and the SPS configuration corresponding to the SPS PDSCH is configured with a third mode, excluding the SPS PDSCH as a candidate SPS PDSCH;
and/or if all symbols of an SPS PDSCH from the multiple SPS PDSCHs overlap with one or more first type symbols and the SPS configuration corresponding to the SPS PDSCH is configured with a fourth mode, excluding the SPS PDSCH as a candidate SPS PDSCH if N symbols of an SPS PDSCH occasion from the multiple SPS PDSCHs overlap with one or more second type symbols and the SPS configuration corresponding to the SPS PDSCH is configured with a third mode, considering the SPS PDSCH occasion as a candidate SPS PDSCH, where L−N>=C, L is a total number of the SPS PDSCH's symbols, C is an integer; and/or
if N symbols of an SPS PDSCH from the multiple SPS PDSCHs overlap with one or more second type symbols and the SPS configuration corresponding to the SPS PDSCH is configured with a third mode, excluding the SPS PDSCH as a candidate SPS PDSCH, where L−N<C, L is a total number of the SPS PDSCH's symbols, C is an integer; and/or
if N symbols of an SPS PDSCH from the multiple SPS PDSCHs overlap with one or more first type symbols and the SPS configuration corresponding to the SPS PDSCH is configured with a fourth mode, considering the SPS PDSCH occasion as a candidate SPS PDSCH, where L−N>=C, L is a total number of the SPS PDSCH's symbols, C is an integer;
and/or if N symbols of an SPS PDSCH from the multiple SPS PDSCHs overlap with one or more first type symbols and the SPS configuration corresponding to the SPS PDSCH is configured with a fourth mode, excluding the SPS PDSCH occasion as a candidate SPS PDSCH, where L−N<C, L is a total number of the SPS PDSCH's symbols, C is an integer;
and/or excluding an SPS PDSCH if one or more resources of the SPS PDSCH overlap with resources of a UL subband; and/or
excluding an SPS PDSCH if all resources of the SPS PDSCH are outside the resources of a DL subband, or if the SPS PDSCH is out of the DL subband; and/or
determining one or more non-excluded SPS PDSCHs as one or more candidate SPS PDSCHs.

47. The method of claim 40, further comprising receiving or transmitting one or more selected SPS PDSCHs determined from one or more candidate SPS PDSCH by performing the steps of:
setting j=0 and designating Q as a set of candidate SPS PDSCHs within a slot;
receiving a SPS PDSCH with the lowest configured sps-ConfigIndex within Q, setting j=j+1, and designating the received SPS PDSCH as a survivor SPS PDSCH;
excluding from Q the survivor SPS PDSCH and any other SPS PDSCHs overlapping with the survivor SPS PDSCH; and
repeating the receiving and excluding steps until Q is empty or j is equal to the number of PDSCHs in a slot supported by the UE.

48. The method of claim 40, wherein a plurality of transmission occasions of uplink and/or downlink transmissions includes at least one of: PDSCH/PUSCH/PUCCH repetitions, SPS PDSCHs/CG PUSCHs, TBoMS, Multi PUSCHs/PDSCHs scheduled by a single DCI, Periodic/semi persistent SRS/CSI-RS/PUCCHs, or PDCCHs.

49. The method of claim 40, wherein:
under the first mode, plurality of transmission occasions of one communication are transmitted or received in a valid symbol type across different slots, wherein the valid symbol type is either SBFD symbols only or non-SBFD symbols only;
under the second mode, all of the plurality of transmission occasions of the one communication are to be transmitted or received in both SBFD symbols and non-SBFD symbols across different slots;
under a third mode, all of the plurality of transmission occasions of the one communication are transmitted or received only in SBFD symbols; and/or
under a fourth mode, all of the plurality of transmission occasions of the one communication are transmitted or received only in non-SBFD symbols; and/or
wherein the SBFD symbols are OFDM symbols in a slot configured with one or more SBFD subbands, and non-SBFD symbols are OFDM symbols in a slot not configured with any SBFD subband; and optionally wherein the SBFD symbols or non-SBFD symbols can be replaced by Co-Frequency Co-Time Full Duplex (CCFD) symbols or non-CCFD symbols, respectively.

50. A wireless communication apparatus, comprising one or more memory units storing one or more programs and one or more processors electrically coupled to the one or more memory units and configured to perform the method of claim 40.
